(19) United States
(12) Patent Application Publication
(10) Pub. No.: US 2017/0153047 A1
(43) Pub. Date: Jun. 1, 2017

(54) Temperature Informing Apparatus

(71) Applicants: Inventec (Pudong) Technology Corporation, Shanghai (CN); INVENTEC CORPORATION, Taipei City (TW)

(72) Inventors: Meng-Lung CHIANG, TAIPEI CITY (TW); Shin-Yi WANG, TAIPEI CITY (TW)

(21) Appl. No.: 15/144,839

(22) Filed: May 3, 2016

(30) Foreign Application Priority Data
Nov. 27, 2015 (CN) 201510851581.4

(51) Int. Cl. F25B 21/04; G01K 1/14; G01K 3/14

(52) U.S. Cl. CPC F25B 21/04; G01K 3/14; G01K 1/14

(57) ABSTRACT

A temperature informing apparatus for a user to actually experience a target temperature includes a thermoelectric conversion module, a temperature sensor, a first current path, a second current path, a charging/discharging element and a micro-processor. The thermoelectric conversion module is disposed between an upper cover and a lower cover of a wearable device. The temperature sensor senses a temperature of the upper cover and the lower cover. The micro-processor compares the temperature with the target temperature to get a temperature difference to calculate a corresponding current and controls the charging/discharging element to transfer the corresponding current to the thermoelectric conversion module to heat up or cool down the upper cover or the lower cover.

### RELATED APPLICATIONS

This application claims priority to Chinese Application Serial Number 201510851581.4, filed Nov. 27, 2015, which is herein incorporated by reference.

### BACKGROUND

Field of Invention

The invention relates to a temperature informing apparatus, and particularly relates to a temperature informing apparatus that allows a user to actually experience a temperature.

Description of Related Art

Typically, both a wearable device and a handheld device have the temperature inquiry function. A user can use this function to search her or his travel region temperature, so as to decide what and how much clothes she/he needs to carry. These devices use numerical or graphical method to show the travel region temperature in a display to inform the user. However, such method often needs to wake up in lock screen for showing the travel region temperature, which is time consuming. Moreover, according to the numerical or graphical temperature, the user at most reads the numerical temperature and the numerical temperature difference between the travel region and the local region. The user cannot experience or feel the real temperature by herself or himself. Therefore, it is difficult for the typical temperature informing method to make the user realize how much clothes she/he needs to carry.

Therefore, a temperature informing apparatus that may solve the aforementioned problems is needed.

### SUMMARY

The present invention provides a temperature informing apparatus for a user to experience a target temperature actually. The temperature informing apparatus includes a thermoelectric conversion module, a temperature sensor, a first current path, a second current path, a charging/discharging element and a micro-processor. The thermoelectric conversion module is disposed between an upper cover and a lower cover of a wearable device. The temperature sensor is disposed on the upper cover and the lower cover to sense a temperature of the upper cover and the lower cover. The first current path and the second current path are coupled with the thermoelectric conversion module. The charging/discharging element is coupled with the first current path and the second current path. The micro-processor for receives the temperature and the target temperature through a transmitting interface. The micro-processor compares the temperature with the target temperature to get a temperature difference. Then, the micro-processor calculates a corresponding current according to the temperature difference and controls the charging/discharging element to transfer the corresponding current to the thermoelectric conversion module to heat up or cool down the upper cover or the lower cover.

In an embodiment, the charging/discharging element transfers the corresponding current through the first current path to the thermoelectric conversion module in a first direction to heat up a temperature of the upper cover and cool down a temperature of the lower cover to make the temperature of the lower cover be equal to the target temperature.

In an embodiment, the charging/discharging element transfers the corresponding current through the second current path to the thermoelectric conversion module in a second direction to heat up a temperature of the lower cover and cool down a temperature of the upper cover to make the temperature of the lower cover be equal to the target temperature.

In an embodiment, a switch unit is disposed among the thermoelectric conversion module, the first current path and the second current path, wherein the micro-processor switches the switch unit to select the first current path or the second current path.

In an embodiment, the transmitting interface is a Bluetooth interface or a WiFi interface.

In an embodiment, the target temperature is stored in a remote database, wherein the remote database is weather forecast center.

In an embodiment, the micro-processor transfers the temperature to the remote database or another user through the transmitting interface.

In an embodiment, the temperature is set through the transmitting interface by a user.

In an embodiment, the temperature sensor further includes a first temperature sensor and a second temperature sensor disposed on the upper cover and the lower cover respectively to detect a temperature of the upper cover and a temperature of the lower cover respectively.

In an embodiment, the thermoelectric conversion module includes a plurality of P-type thermal-electric material and a plurality of N-type thermal-electric material coupled in series in a P-N pair formed.

Accordingly, in conjunction with a current path providing unit to provide different charging current paths, the thermoelectric conversion module of the charging/discharging apparatus may charge the charging and discharging element whether the user's body temperature is higher than the ambient air temperature or not. Therefore, the present invention may reach the purpose of making full use of the temperature difference.

Because the described procedure identifies differentially expressed genes separately from each data set, its application is not limited by platform differences and its effectiveness is not affected by batch effects.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the embodiment described below, with reference made to the following drawings:

FIG. 1 illustrates a schematic diagram of a temperature informing apparatus according to a preferred embodiment of the present invention.

FIG. 2A and FIG. 2B illustrate a schematic diagram of a wearable device.

FIG. 3 illustrates a schematic diagram of an application of the temperature informing apparatus according to a preferred embodiment of the present invention.

### DETAILED DESCRIPTION

Reference will now be made in detail to the present embodiment of the invention, workflow of which is illustrated in the accompanying drawings. The same reference numbers are used in the drawings and in the description to refer to the same parts.

The present invention temperature informing apparatus uses a thermoelectric conversion module to perform a thermoelectric conversion process according to a current corresponding to a temperature difference between a target temperature and a current temperature to heat up or cool down the upper cover and the lower cover of a wearable device. Such apparatus allows the body of a user experience the target temperature actually through the wearable device may. Therefore, the user may better understand what and how much clothes they need to carry.

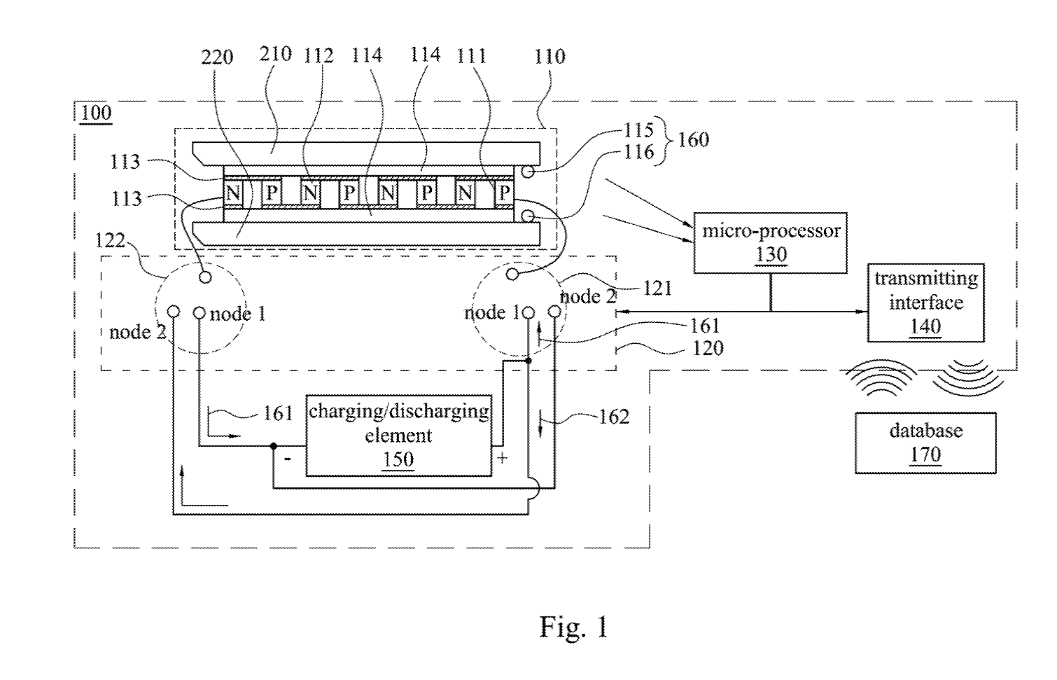

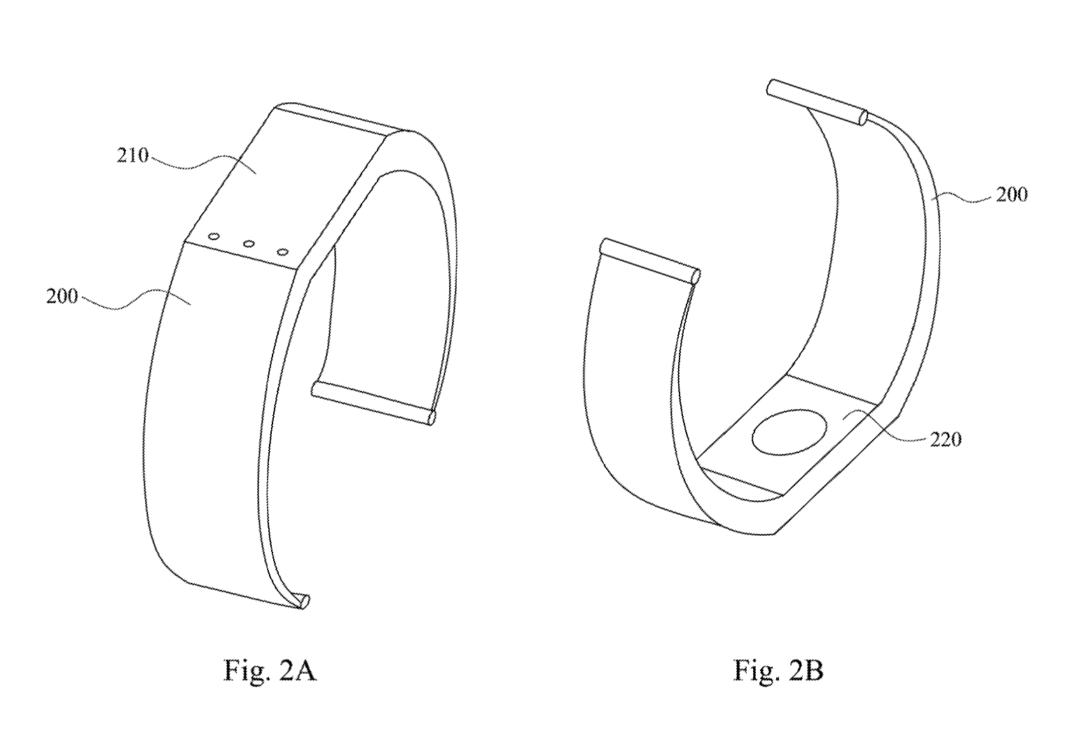

FIG. 1 illustrates a schematic diagram of a temperature informing apparatus according to a preferred embodiment of the present invention. This temperature informing apparatus can actually generate a target temperature to allow a user to instantly experience the feeling of this target temperature, and the differences comparing with the current temperature. FIG. 2A and FIG. 2B illustrates a schematic diagram of a wearable device. The wearable device 200 includes an upper cover 210 and a lower cover 220. The temperature informing apparatus of the present invention is disposed between the upper cover 210 and the lower cover 220 of the wearable device 200. The lower cover 220 closes to the skin of the user and the upper cover 210 closes to the ambient air. Therefore, when the user wear the wearable device 200, the temperature informing apparatus may heat up or cool down the upper cover 210 and the lower cover 220 to make the body of a user close to the lower cover 220 to experience the target temperature actually.

As illustrated in FIG. 1, the temperature informing apparatus 100 includes a thermoelectric conversion module 110, a switching unit 120, a micro-processor 130, a transmitting interface 140, a charging/discharging element 150 and a temperature sensor 160. The charging/discharging element 150 may provide current to the thermoelectric conversion module 110. In an embodiment, the charging/discharging element 150 is a battery or a capacitor that may be charged and discharged repeated. The transmitting interface 140 is a Bluetooth or a WiFi interface. The micro-processor 130 may couple with a remote database 170 to search a destination temperature to get a target temperature through the transmitting interface 140. The remote database 170 is a database provided by a weather forecast center.

The thermoelectric conversion module 110 may perform an energy conversion between the electrical energy and thermal energy. In an embodiment, the thermoelectric conversion module 110 may be disposed between the upper cover 210 and the lower cover 220 of the wearable device 200. The thermoelectric conversion module 110 may heat up or cool down the upper cover 210 and the lower cover 220 according to a current provided by the charging/discharging element 150. The thermoelectric conversion module 110 includes a plurality of P-type thermal-electric material 111 and a plurality of N-type thermal-electric material 112 coupled in series in a P-N pair formed. In one embodiment, the P-type thermal-electric material 111 and the N-type thermal-electric material 112 may be formed by bismuth tellurium compounds or tellurium compounds. One end of the P-type thermal-electric material 111 and one end of the N-type thermal-electric material 112 in a PN pair are connected together through a conductive plate 113. The other end of the P-type thermal-electric material 111 and the other end of the N-type thermal-electric material 112 in a PN pair are connected to other two adjacent PN pairs through two conductive plates 113 respectively to form a series connection structure. The conductive plate 113 is used to perform electrical and thermal conduction. In one embodiment, a copper material with good electrical and thermal conduction is selected to form the conductive plate 113. An electrically insulating thermal coupling layer 114 is further formed between the conductive plate 113 and the upper cover 210, and the conductive plate 113 and the lower cover 220. In one embodiment, a material with good electrical insulation as well as heat transferring property, such as beryllium oxide ceramics, may be used to form the thermal coupling layer 114.

Temperature sensor 160 includes a first temperature sensor 115 and a second temperature sensor 116 that are respectively disposed on the sides of the P-type thermal-electric material 111 in the upper cover 210 and the lower cover 220 for sensing the temperature of the upper cover 210 and the lower cover 220. The sensed temperature is transferred to the micro-processor 130. The micro-processor 130 may transfer the temperature sensed by the temperature sensor 160 to the remote database 170 and search the remote database 170 to get a target temperature through the transmitting interface 140. In an embodiment, the transmitting interface 140 is a Bluetooth or a WiFi transmitting interface. Accordingly, the micro-processor 130 compares the temperature sensed by the temperature sensor 160 with the target temperature and controls the thermoelectric conversion module 110 to heat up or cool down the upper cover 210 and the lower cover 220 according to the comparing result.

On the other hand, the switch unit 120 includes a first switch 121 and a second switch 122. The switch unit 120 is disposed between the thermoelectric conversion module 110 and the charging/discharging element 150. The micro-processor 130 calculates a corresponding current according to the comparing result and switches the first switch 121 and the second switch 122 to select a first current path 161 or a second current path 162 for the charging/discharging element 150. Then, the charging/discharging element 150 may provide the corresponding current to the thermoelectric conversion module 110 through the first current path 161 or the second current path 162. Accordingly, when the micro-processor 130 switches the first switch 121 and the second switch 122 to couples with the node 1 to select the first current path 161 with a first direction current, since the moving direction of the majority carriers (holes) is same as the flowing direction of the current in the P-type thermal-electric material 111, the carriers (holes) with energy are accumulated in the upper cover 210. On the other hand, since the moving direction of the majority carriers (electrodes) is opposite to the flowing direction of the current in the N-type thermal-electric material 112, the carriers (electrodes) with energy are accumulated in the upper cover 210, too. Because all carriers with energy are accumulated in the upper cover 210, the temperature of the upper cover 210 is increased. On the other hand, because all carriers with energy are far away from the lower cover 220, the temperature of the lower cover 220 is reduced.

In contrast, when the micro-processor 130 switches the first switch 121 and the second switch 122 to couples with the node 2 to select the second current path 162 with a second direction current, since the moving direction of the majority carriers (holes) is same as the flowing direction of the current in the P-type thermal-electric material 111, the carriers (holes) with energy are accumulated in the lower cover 220. On the other hand, since the moving direction of the majority carriers (electrodes) is opposite to the flowing direction of the current in the N-type thermal-electric material 112, the carriers (electrodes) with energy are accumulated in the lower cover 220, too. Because all carriers with energy are accumulated in the lower cover 220, the temperature of the lower cover 220 is increased. On the other hand, because all carriers with energy are far away from the upper cover 210, the temperature of the upper cover 210 is reduced. Accordingly, the micro-processor 130 can switches the first switch 121 and the second switch 122 to control the charging/discharging element 150 to transmit current to the thermoelectric conversion module 110 through the first current path 161 or the second current path 162 to heat up or cool down the upper cover 210 or the lower cover 220 according to the comparing result.

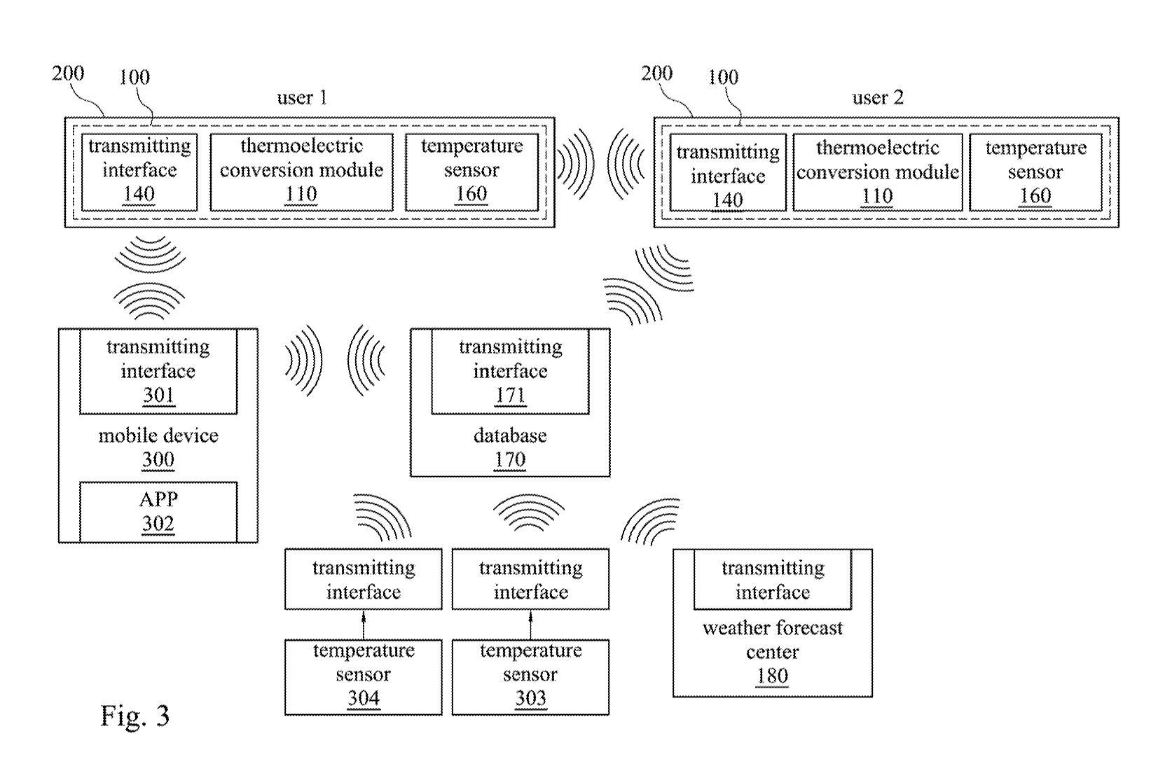

FIG. 3 illustrates a schematic diagram of an application of the temperature informing apparatus according to a preferred embodiment of the present invention. For explaining this application, only the thermoelectric conversion module 110, the transmitting interface 140 and the temperature sensor 160 are illustrated in the temperature informing apparatus 100. This temperature informing apparatus 100 is disposed in a user's wearable device 200. In one embodiment, when the transmitting interface 140 is a Bluetooth transmitting module, such as the user 1, the transmitting interface 140 of the temperature informing apparatus 100 is connected to a transmitting interface 301 of the mobile device 300. Then, the temperature informing apparatus 100 can connect with the transmitting interface 171 of the remote database 170 through the mobile device 300 to download or upload the required information. In another embodiment, when the transmitting interface 140 is a WiFi transmitting module, such as the user 2, the temperature informing apparatus 100 may be directly connected to the transmitting interface 171 of the remote database 170 to download or upload the required information. The remote database 170 may be coupled to a weather forecast center 180 to obtain the forecast temperature. In addition, the remote database 170 may also be coupled with the temperature sensors 303, 304 located in other positions. Accordingly, each user can get a present temperature of a wanted region or a travel destination, or get a forecast temperature at a specific time of a specific location. In addition, since the temperature informing apparatus 100 of both user 1 and user 2 has the transmitting interface 140, the user 1 and the user 2 can be directly or indirectly connected together through their temperature informing apparatus 100 to track and transmit the body temperature or the ambient air temperature to each other. Especially, in the medical application, the user 1 and the user 2 may monitor the body temperature in real-time to each other by using the temperature informing apparatus 100.

In an embodiment, as illustrated in FIG. 3, the mobile device 300 of a user may download an application program (APP) 302. The user can set the travel location and travel time in the APP 302. Then, the transmitting interface 301 of the mobile device 300 is connected to the transmitting interface 171 of the remote database 170 to search the forecast temperature at the specific travel time of the specific travel location to act as a target temperature. The target temperature is transferred to the temperature informing apparatus 100 of the user through the mobile device 300. Before traveling, the temperature informing apparatus 100 is automatically or manual triggered through a switch to control the thermoelectric conversion module 110 to heat up or cool down the upper cover 210 and the lower cover 220 of the wearable device 200 according to the comparing result between the temperature sensed by the temperature sensor 160 and the target temperature. A setting time or a setting temperature difference can be used as a condition to automatically trigger the temperature informing apparatus 100. For example, when the target temperature is lower than the temperature sensed by the temperature sensor 160, the micro-processor 130 is triggered to switch the first switch 121 and the second switch 122 to couple with the node 1. Accordingly, the charging/discharging element 150 may transmit current to the thermoelectric conversion module 110 through the first current path 161 to cool down the temperature of the lower cover 220 to the target temperature to let the user have a real experience for the temperature. In contrast, when the target temperature is higher than the temperature sensed by the temperature sensor 160, the micro-processor 130 is triggered to switch the first switch 121 and the second switch 122 to couple with the node 2. Accordingly, the charging/discharging element 150 may transmit current to the thermoelectric conversion module 110 through the second current path 162 to heat up the temperature of the lower cover 220 to the target temperature to let the user have a real experience for the temperature.

In another embodiment, the user can set a wanted temperature as the target temperature in the APP 302 through the transmitting interface 301 and transmit the wanted temperature to the temperature informing apparatus 100. Accordingly, when the user takes an exercise to cause his body temperature higher than the target temperature, or when the user goes into an air-conditioned room to cause his body temperature lower than the target temperature, the temperature difference with the target temperature in the both situation triggers the micro-processor 130 in the temperature informing apparatus 100 to control the charging/discharging element to transfer a corresponding current concerned with the temperature difference to the thermoelectric conversion module to heat up or cool down the lower cover to make the user experience the target temperature actually.

Accordingly, the temperature informing apparatus generates a corresponding current according to a temperature difference between a target temperature and a current temperature. The corresponding current is provided to a thermoelectric conversion module to heat up or cool down the upper cover or the lower cover of a wearable device. Therefore, the user can experience the target temperature actually through the wearable device.

Although the present invention has been described in considerable detail with reference to an embodiment thereof, other embodiments are possible. Therefore, the spirit and scope of the appended claims should not be limited to the description of the embodiment contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A temperature informing apparatus for a user to actually experience a target temperature, the apparatus comprising:
a thermoelectric conversion module disposed between a upper cover and a lower cover of a wearable device;
a temperature sensor disposed on the upper cover and the lower cover to sense a temperature of the upper cover and the lower cover;
a first current path and a second current path coupling with the thermoelectric conversion module;
a charging/discharging element coupled with the first current path and the second current path; and
a micro-processor for receiving the temperature and the target temperature through a transmitting interface,
wherein the micro-processor compares the temperature with the target temperature to get a temperature difference, and the micro-processor calculates a corresponding current according to the temperature difference and control the charging/discharging element to transfer the corresponding current to the thermoelectric conversion module to heat up or cool down the upper cover or the lower cover.

2. The temperature informing apparatus of claim 1, wherein the charging/discharging element transfers the corresponding current through the first current path to the thermoelectric conversion module in a first direction to heat up a temperature of the upper cover and cool down a temperature of the lower cover to make the temperature of the lower cover be equal to the target temperature.

3. The temperature informing apparatus of claim 1, wherein the charging/discharging element transfers the corresponding current through the second current path to the thermoelectric conversion module in a second direction to heat up a temperature of the lower cover and cool down a temperature of the upper cover to make the temperature of the lower cover be equal to the target temperature.

4. The temperature informing apparatus of claim 1, further comprising a switch unit disposed among the thermoelectric conversion module, the first current path and the second current path, wherein the micro-processor switches the switch unit to select the first current path or the second current path.

5. The temperature informing apparatus of claim 1, wherein the transmitting interface is a Bluetooth interface or a WiFi interface.

6. The temperature informing apparatus of claim 1, wherein the target temperature is stored in a remote database, wherein the remote database is weather forecast center.

7. The temperature informing apparatus of claim 6, wherein the micro-processor transfers the temperature to the remote database or another user through the transmitting interface.

8. The temperature informing apparatus of claim 1, wherein the temperature is set through the transmitting interface by a (the?) user.

9. The temperature informing apparatus of claim 1, wherein the temperature sensor further comprises a first temperature sensor and a second temperature sensor disposed on the upper cover and the lower cover respectively to detect a temperature of the upper cover and a temperature of the lower cover respectively.

10. The temperature informing apparatus of claim 1, wherein the thermoelectric conversion module comprises a plurality of P-type thermal-electric material and a plurality of N-type thermal-electric material coupled in series in a P-N pair formed.
